(19) United States
(12) Patent Application Publication
(10) Pub. No.: US 2003/0142219 A1
(43) Pub. Date: Jul. 31, 2003

(54) LOW NOISE CLOCK GENERATION CIRCUIT FOR A DIGITAL CAMERA

(76) Inventors: JAMES E. MCGARVEY, HAMLIN, NY (US); MARTIN POTUCEK, AUSTIN, TX (US)

Correspondence Address: PATENT LEGAL STAFF, EASTMAN KODAK COMPANY, 343 STATE STREET, ROCHESTER, NY, 14650-2201, US

(21) Appl. No.: 09/210,316

(22) Filed: Dec. 11, 1998

(51) Int. Cl. H04N 3/14

(52) U.S. Cl. 348/222.1

(57) ABSTRACT

Electronic imaging apparatus having an image sensor for capturing an image \and for transferring such image to an analog-to-digital (A/D) converter which produces a digital image signal representative of the captured image is disclosed. The electronic imaging apparatus comprises an analog section including circuitry for producing an oscillator driven clock signal, a timing generator for controlling the operation of the image sensor and the A/D converter, and circuitry responsive to the oscillator driven clock signal for producing a master clock signal. The electronic imaging apparatus further includes a digital processing section including a control processor responsive to the master clock signal for producing a plurality of image sensor control signals; and the timing generator being responsive to the image sensor control signals and the oscillator driven clock signal for producing timing signals to control the operation of the image sensor and the A/D converter.

### FIELD OF THE INVENTION

The invention relates generally to the field of electronic imaging, and in particular, to clock generation for a digital camera.

### BACKGROUND OF THE INVENTION

A digital camera, such as the Kodak Digital Science DC40™ camera, sold by the Eastman Kodak Company, typically includes two types of circuits. The first type is an analog circuit which includes analog imaging related components, such as an image sensor, sensor clock drivers, an analog signal processor (ASP), and an analog-to-digital (A/D) converter. The second type is a digital circuit including digital timing and image processing components. Typically, the analog imaging related components are implemented together in an assembly consisting of one or more printed circuit boards (PCBs) in order to isolate the analog imaging related components as much as possible from the noise producing digital components. In this case, the timing waveforms are generated in the digital assembly and provided to the analog imaging assembly via a cable or other electrical interconnection. Unfortunately, generating multiple timing signals on a digital board some distance from the sensor clock drivers, and allowing these signals to travel together along a cable, can introduce some amount of skew (i.e., variable time delays between the signals) and noise. This can cause noise and spurious signals to be introduced into the image captured by the sensor, thus decreasing the image quality.

### SUMMARY OF THE INVENTION

Accordingly, it is an object of the present invention to generate clock signals to control an image sensor in a digital camera while minimizing noise and skew.

This object is achieved by electronic imaging apparatus having an image sensor for capturing an image and for transferring such image to an analog-to-digital (A/D) converter which produces a digital image signal representative of the captured image, comprising:

(a) an analog section including:

(i) means for producing an oscillator driven clock signal;

(ii) a timing generator for controlling the operation of the image sensor and the A/D converter; and

(iii) means responsive to the oscillator driven clock signal for producing a master clock signal;

(b) a digital processing section including a control processor responsive to the master clock signal for producing a plurality of image sensor control signals; and

(c) the timing generator being responsive to the image sensor control signals and the oscillator driven clock signal for producing timing signals to control the operation of the image sensor and the A/D converter.

### ADVANTAGES

It is an advantage of the present invention to provide electronic imaging apparatus including an image sensor for capturing a digital image with reduced noise and skew, thus increasing image quality.

### BRIEF DESCRIPTION OF THE DRAWINGS

FIG. 1 is a block diagram of an exemplary digital camera in which the present invention can be utilized;

FIG. 2 is a block diagram of the master clock generator circuit of FIG. 1; and

FIG. 3 is a block diagram of the Programmable Logic Device of FIG. 1 in more detail.

### DETAILED DESCRIPTION OF THE INVENTION

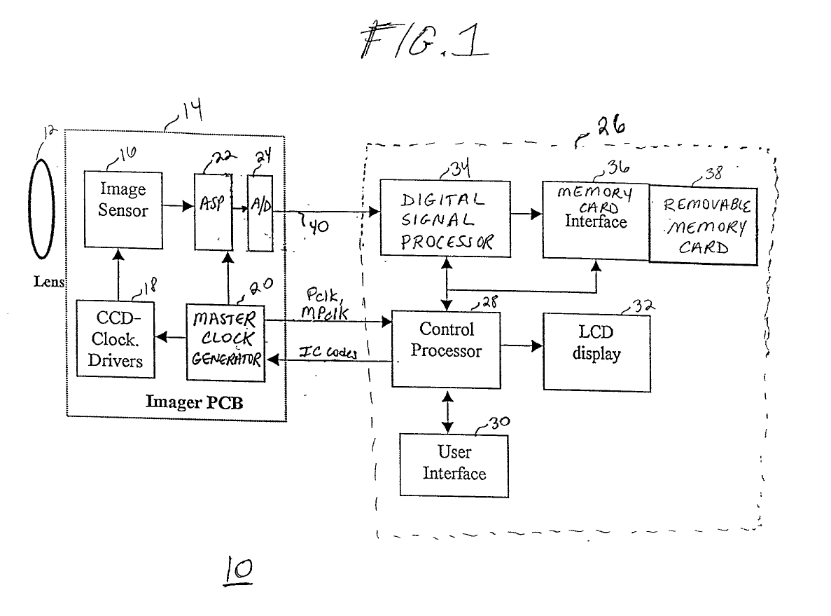

FIG. 1 shows a block diagram of an exemplary digital camera 10 in which the present invention can be utilized, such as, for example, the Kodak Digital Science DCS520O™ camera sold by the Eastman Kodak Company. As shown in FIG. 1, the digital camera 10 includes a lens 12 and an analog imager printed circuit board (PCB) 14. The analog imager PCB 14 includes an image sensor 16, which can be a conventional charge-coupled device (CCD) such as the Kodak KAF 2000CE sensor, a plurality of CCD clock drivers 18, a master clock generator 20 having a crystal clock (not shown), an analog signal processor (ASP) 22 and an analog-to-digital (A/D) converter 24. By conveniently mounting the image sensor 16, the CCD clock drivers 18, the master clock generator 20, the ASP 22, and the A/D converter 24 on one PCB, jitter is substantially reduced since the phase of the crystal clock is not jittered by ground bounce between the crystal clock and the master clock generator 20.

In operation, the lens 12 directs incident light upon the image sensor 16, which has a discrete number of photosite elements or pixels arranged in a two-dimensional array to form individual photosites corresponding to the pixels of the image. The photosites of the image sensor 16 convert the incident photons of light into electron charge packets. Each photosite is overlaid with a color filter array (CFA), such as the Bayer CFA described in commonly-assigned U.S. Pat. No. 3,971,065, the disclosure of which is herein incorporated by reference. The Bayer CFA has 50% green pixels in a checkerboard mosaic, with the remaining pixels alternating between red and blue rows. The photosites respond to the appropriately colored incident light illumination to provide an analog signal corresponding to the intensity of illumination incident on the photosites.

The analog output of each pixel is amplified and analog processed by the ASP 22 to reduce the output amplifier noise of the image sensor 16. The output of the ASP 22 is converted to a digital image signal 40 by the A/D converter 24, such as, for example, a 12 bit A/D converter which provides a 12 bit signal in the sequence of the Bayer CFA.

As shown in FIG. 1, the digital camera 10 further includes a digital section 26, which is implemented over several PCBs. The digital section 26 includes a control processor 28 which produces clock signals needed by the digital section 26 and image sensor control codes (IC codes) used by the master clock generator 20 on the analog imager PCB 14. The control processor 28 receives user inputs (not shown), such as from a shutter release (not shown), and initiates a capture sequence by signaling the CCD clock drivers 18 via the master clock generator 20 to produce the analog image signal. The control processor 28 also controls an image display 32, such as a color liquid crystal display (LCD), where a user can view the captured image, and a user interface 30 to control the operation of the digital camera 10 in a manner well known. The control processor 28 can be, for example, a Motorola 821 Power PC microprocessor.

The digital section 26 further includes a digital signal processor 34 that can perform functions such as defect correction, CFA interpolation, white balance, color correction, tone correction, image sharpening, and compression on the digital image signal 40. The processed digital image signal can then be transferred through a memory card interface 36 to a removable memory card 38 where it is stored. The memory card 38 can be adapted to the PCMCIA card interface standard, such as described in the PC Card Standard, Release 2.0, published by the Personal Computer Memory Card International Association, Sunnyvale, Calif., Sep., 1991.

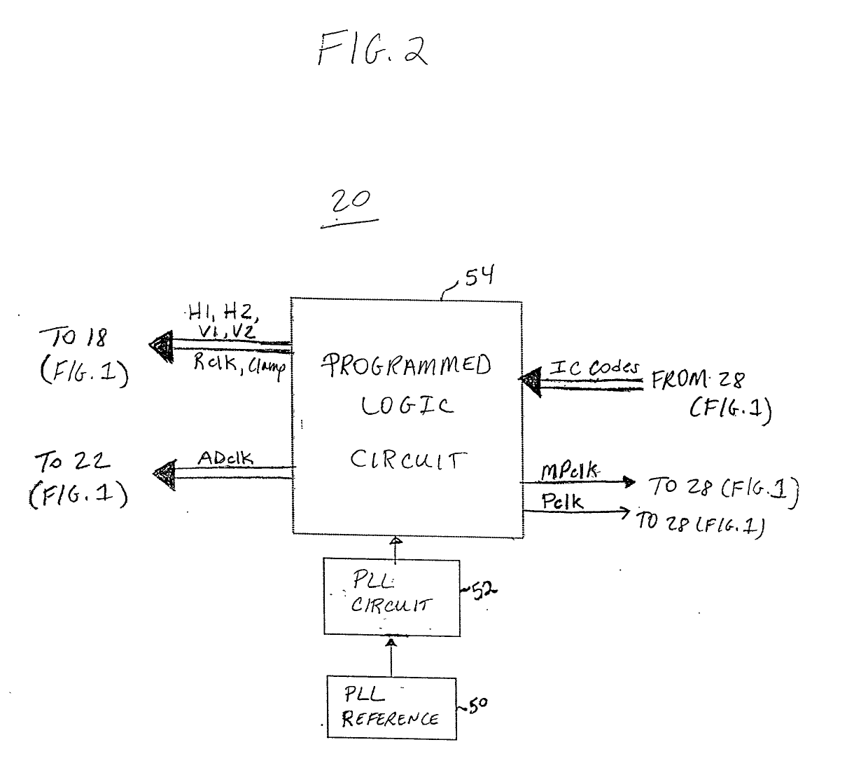

Referring now to FIG. 2, a diagram of the master clock generator circuit 20 of FIG. 1 is shown in more detail. As shown, a Phase-Locked Loop (PLL) reference 50 is provided by an oscillator driven clock on the analog imager PCB 14. Preferably, the oscillator driven clock is a 24.576 MHz crystal oscillator. A conventional PLL circuit 52 produces an 80 MHz clock signal from the crystal PLL reference 50. The 80 MHz clock signal from the PLL circuit 52 is provided to a programmed logic circuit (PLC) 54. In accordance with the present invention, the PLC 54 produces a 10 MHz master pixel clock signal (MPclk), which is provided to the control processor 28 in the digital section 26 (shown in FIG. 1). The control processor 28 uses MPclk to clock counters located internal to the control processor 28 which count the pixels per line and lines per image. MPclk also clocks a PLL circuit (not shown) in the control processor 28 which is used to produce higher speed clock signals used by the control processor 28 to transfer image data to the LCD image display 32 and to the removable memory card 38 (shown in FIG. 1).

The control processor 28 produces image sensor control codes (IC codes), which are provided to the PLC 54 on the analog imager PCB 14 to control the timing of the image sensor 16. In accordance with the present invention, the PLC 54 uses the IC codes from the control processor 28 and the 10 MHz MPclk to produce a plurality of pixel rate clock signals with various phases and duty cycles, and which are used to control the image sensor 16, the ASP 22, and the A/D converter 24 shown in FIG. 1.

The pixel rate clock signals produced by the PLC 54 are well known and include horizontal image sensor clock signals (H1 and H2), an image sensor reset clock signal (Rclk), an A/D converter clock signal (ADclk), a clamp signal, and a pixel clock signal (Pclk). H1 and H2 are complementary clock signals which shift a line of pixels from the horizontal register of the image sensor 16 and deposit the line of pixels into the floating diffusion output structure, where it is converted to a voltage. Rclk discharges the floating diffusion after each pixel has been output in order to prepare for the next pixel, and ADclk signals the A/D converter 24 to sample each pixel value after the output from the image sensor 16 has settled. The clamp signal samples the reset level of each pixel, which is the level of the floating diffusion (charge to voltage conversion) cell in the image sensor 16 prior to shifting in each pixel's charge. The cell is reset by Rclk and sampled. The pixel electrons are then shifted in and sampled again to provide a voltage. The difference between these voltages is the value of that pixel. Pclk is provided to the control processor 28 to indicate to the digital signal processor 34 that valid pixel data is being sent from the A/D converter 24.

In addition to the above pixel rate clock signals, the PLC 54 on the analog imager PCB 14 produces two well known vertical image sensor clock signals, V1 and V2. In accordance with the present invention, V1 and V2 are directly decoded from the IC codes 44, and are used to shift full lines of pixels into the horizontal register of the image sensor 16.

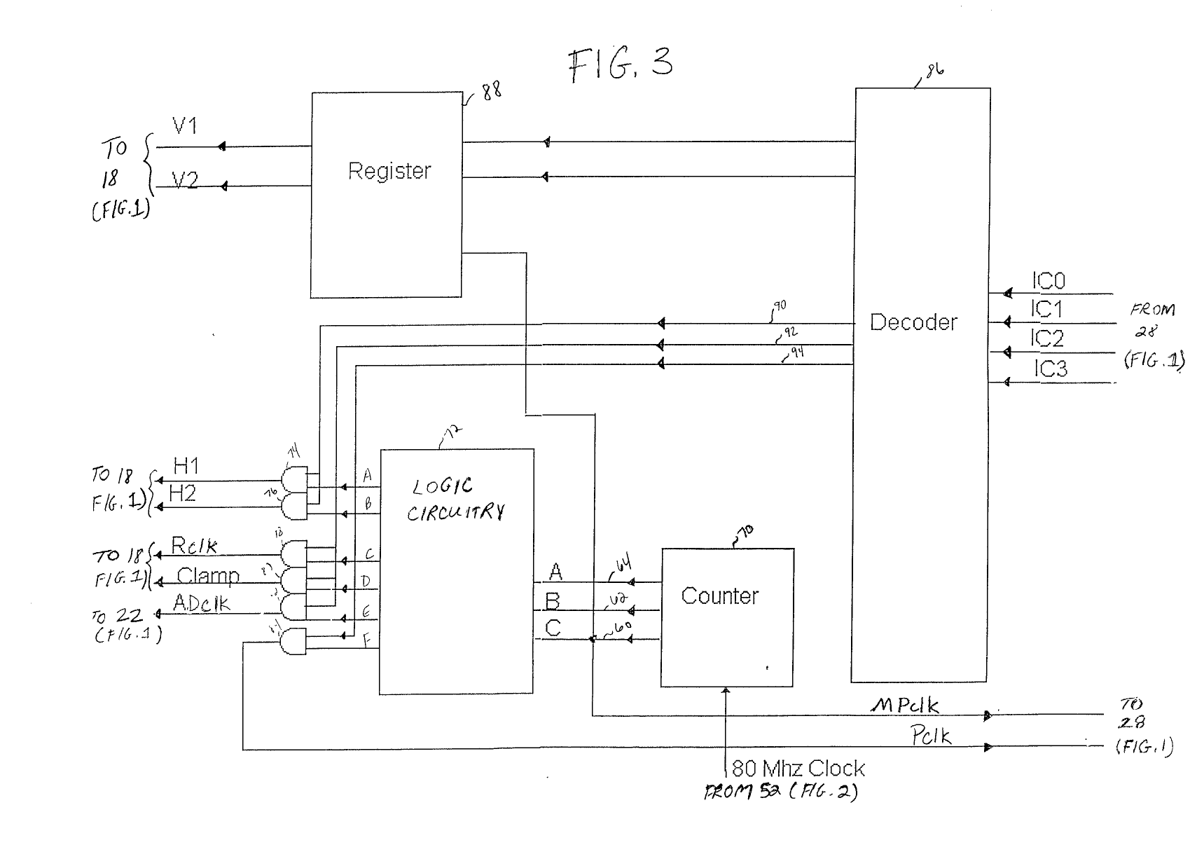

Referring now to FIG. 3, a block diagram of the PLC 54 of FIG. 2 is shown in more detail. As shown, the 80 MHz clock signal from the PLL circuit 52 is provided to a 3 bit binary counter 70 which divides the 80 MHz clock signal to the 10 MHz master pixel clock signal (MPclk). The 3 bit binary counter 70 also provides sub-pixel timing to logic circuitry 72 through signals over leads 62 and 64. MPclk is provided to the control processor 28 (shown in FIG. 1) over lead 60, and is used for timing of the IC codes. The logic circuitry 72, in response to the sub-pixel timing, produces signals over leads A-F. AND gates 74-84 receive the signals from the logic circuitry 72 and produce pixel rate clock signals H1, H2, Rclk, the clamp signal, ADclk, and Pclk, respectively, as shown in FIG. 3.

Four IC codes (IC0, IC1, IC2, IC3) from the control processor 28 (shown in FIG. 1) are provided to a decoder 86. The decoder 86 uses the IC codes to produce the vertical image sensor clock signals (V1, V2), which are synchronized locally with MPclk by a register 88. The register 88 can be provided by D flip-flops which are well known to those skilled in the art. The decoder 86 also produces enable signals over leads 90, 92, and 94 which continuously gate the AND gates 74-84 to produce H1, H2, Rclk, the clamp signal, ADclk, and Pclk.

The IC codes from the control processor 28 are used to control the timing of the image sensor 16. In particular, the four IC codes, IC0, IC1, IC2, and IC3, are used to produce four combinations of H1, H2, Rclk, the clamp signal, ADclk, and Pclk. When the image sensor 16 is in an idle mode, H1, H2, Rclk, the clamp signal, and ADclk are all off. During integration and vertical clock intervals, Rclk, ADclk, and the clamp signal are on. During transfer and flush of non-transferred pixel electrons, Rclk, ADclk, H1, H2, and the clamp signal are on. Finally, H1, H2, Rclk, ADclk, and the clamp signal are all on to cause the analog signal processor 22 (shown in FIG. 1) to accept the pixel data (analog voltage). Pclk controls the timing of the digital signal processor 34. The timing of H1, H2, Rclk, ADclk, the clamp signal, and Pclk depends on the architecture of the image sensor 16. See, for example, the specification sheet for the Kodak KAF 2000CE sensor sold by the Eastman Kodak Company.

The following table depicts seven modes of operation of the circuitry shown in FIG. 3, and corresponding states of the IC codes IC0, IC1, IC2, and IC3, which are used to produce the four combinations of the pixel rate clock signals. In the table, “0” refers to logic 0 (i.e., low state) and “1” refers to logic 1 (i.e., high state). In the “Clocks On” column, the various pixel rate clock signals are on for a given mode when they are listed. If a particular pixel rate clock signal is not listed for a given mode, it is off for that mode.

TABLE I

| Mode | IC3 | IC2 | IC1 | IC0 | Clocks On |
|---|---|---|---|---|---|
| 1 (Idle) | 0 | 0 | 0 | 0 | None |
| 2 | 0 | 0 | 1 | 1 | V1, H1, H2, Rclk, Clamp, ADclk |
| 3 | 0 | 1 | 1 | 1 | V2, H1, H2, Rclk, Clamp, ADclk |
| 4 | 0 | 0 | 1 | 0 | V1 |
| 5 | 0 | 1 | 0 | 0 | V2 |
| 6 | 0 | 0 | 0 | 1 | H1, H2, Rclk, Clamp, ADclk |
| 7 (Save) | 1 | 0 | 1 | 1 | H1, H2, Rclk, Clamp, ADclk, Pclk |

Mode 1 occurs in the period between the other modes when the image sensor 16 is idle. Modes 2 and 3 occur when the electrons are drained from the image sensor 16. H1 and H2 must be on during modes 2 and 3 to remove charge from the horizontal register. Modes 4 and 5 occur during image transfer. During modes 4 and 5, H1 and H2 do not run when V1 and V2 are on. Mode 6 occurs when a pixel line is being transferred from the horizontal register to the analog signal processor 22 (shown in FIG. 1). The dead and black pixels at the ends of a pixel line are not saved during mode 6. Mode 7 occurs during transfer of image data corresponding to a portion of a pixel line to the digital signal processor 34.

It can be appreciated that in the present invention, since the master pixel rate clock signal (MPclk) is generated on the analog imager PCB 14, rather than having it generated on the digital section 26 and sent via cable to the analog imager PCB 14 as in prior art cameras, jitter and noise are substantially reduced. Image quality significantly improves with the reduction of jitter and noise.

The invention has been described with reference to a preferred embodiment. However, it will be appreciated that variations and modifications can be effected by a person of ordinary skill in the art without departing from the scope of the invention.

### PARTS LIST

10 digital camera

12 lens

14 analog imager printed circuit board

16 image sensor

18 CCD clock drivers

20 master clock generator

22 analog signal processor

24 analog-to-digital converter

26 digital section

28 control processor

30 user interface

32 image display

34 digital signal processor

36 memory card interface

38 removable memory card

40 digital image signal

50 Phase-Locked Loop reference

52 Phase-Locked Loop circuit

54 programmed logic circuit

60 lead

62 lead

64 lead

70 3 bit binary counter

72 logic circuitry

74 AND gate

76 AND gate

78 AND gate

80 AND gate

82 AND gate

84 AND gate

86 decoder

88 register

90 lead

92 lead

94 lead

H1, H2 horizontal clock signals

V1, V2 vertical clock signals

Rclk image sensor reset clock signal

ADclk analog-to-digital converter clock signal

Clamp clamp signal

Pclk pixel clock signal

MPclk master pixel clock signal

1. Electronic imaging apparatus having an image sensor for capturing an image and for transferring such image to an analog-to-digital (A/D) converter which produces a digital image signal representative of the captured image, comprising:
(a) an analog section including:
(i) means for producing an oscillator driven clock signal;
(ii) a timing generator for controlling the operation of the image sensor and the A/D converter; and
(iii) means responsive to the oscillator driven clock signal for producing a master clock signal;
(b) a digital processing section including a control processor responsive to the master clock signal for producing a plurality of image sensor control signals; and
(c) the timing generator being responsive to the image sensor control signals and the oscillator driven clock signal for producing timing signals to control the operation of the image sensor and the A/D converter.

2. Electronic imaging apparatus having an image sensor for capturing an image and for transferring such image to an analog-to-digital (A/D) converter which produces a digital image signal representative of the captured image, comprising:
(a) an analog section including:
(i) means for producing an oscillator driven clock signal;
(ii) a timing generator for producing vertical, horizontal and reset image sensor clock signals to control the operation of the image sensor and for producing an A/D control signal to control the operation of the A/D converter; and
(iii) means responsive to the oscillator driven clock signal for producing a master clock signal;
(b) a digital processing section including a control processor responsive to the master clock signal for producing a plurality of image sensor control signals; and
(c) the timing generator being responsive to the image sensor control signals and the oscillator driven clock signal for producing the vertical, horizontal and reset image sensor clock signals to control the operation of the image sensor and for producing the A/D control signal to control the operation of the A/D converter.

3. The electronic imaging apparatus according to claim 2 wherein the control processor further produces a plurality of clock signals to control processing and storage of the digital image signal produced by the A/D converter.

4. Electronic imaging apparatus having an image sensor for capturing an image and for transferring such image to an analog-to-digital (A/D) converter which produces a digital image signal representative of the captured image, comprising:
(a) an analog section including:
(i) a first printed circuit board;
(ii) means mounted on the printed circuit board for producing an oscillator driven clock signal;
(iii) a timing generator mounted on the printed circuit board for controlling the operation of the image sensor and the A/D converter; and
(iv) means mounted on the printed circuit board and responsive to the oscillator driven clock signal for producing a master clock signal;
(b) a digital processing section including a control processor responsive to the master clock signal for producing a plurality of image sensor control signals; and
(c) the timing generator being responsive to the image sensor control signals and the oscillator driven clock signal for producing timing signals to control the operation of the image sensor and the A/D converter.

5. The electronic imaging apparatus according to claim 4 wherein the digital processing section is mounted on a second printed circuit board.

6. The electronic imaging apparatus according to claim 5 wherein the first and second printed circuit boards are connected by a cable.

7. Electronic imaging apparatus having an image sensor for capturing an image and for transferring such image to an analog-to-digital (A/D) converter which produces a digital image signal representative of the captured image, comprising:
(a) an analog section including:
(i) means for producing a first clock signal;
(ii) a timing generator for controlling the operation of the image sensor and the A/D converter and the transfer of the image to the A/ID converter; and
(iii) means responsive to the first clock signal for producing a second clock signal;
(b) a digital processing section including a control processor responsive to the second clock signal for producing a plurality of image sensor control signals; and
(c) the timing generator being responsive to the image sensor control signals and the first clock signal for producing timing signals to control the operation of the image sensor and the A/D converter and the transfer of the image to the A/D converter.
